(19) United States
(12) Patent Application Publication
(10) Pub. No.: US 2001/0046617 A1
(43) Pub. Date: Nov. 29, 2001

(54) Fuel cell system and method for operating a fuel cell system

(76) Inventors: Gregor Gold, Heidenheim (DE); Bruno Motzet, Weilheim/Teck (DE); Martin Schaefer, Kirchheim/Teck (DE); Andreas Schukraft, Karlsruhe (DE); Alexander Suess, Owen (DE); Alois Tischler, Aidenbach (DE)

Correspondence Address: EVENSON, MCKEOWN, EDWARDS & LENAHAN, P.L.L.C., Suite 700, 1200 G Street, Washington, DC, 20005, US

(21) Appl. No.: 09/820,319

(22) Filed: Mar. 29, 2001

(30) Foreign Application Priority Data
Mar. 29, 2000 (DE) 100 15 653.3

(51) Int. Cl. H01M 8/04

(52) U.S. Cl. 429/26; 429/24; 429/13

(57) ABSTRACT

A fuel cell system (and a method for operating it) includes at least one fuel cell with an anode space and a cathode space, a first medium supply line for supplying a first medium to the anode space, a first medium outlet line for removing an outgoing anode stream from the anode space, a second medium supply line for supplying a second medium to the cathode space, a second medium outlet line for removing an outgoing cathode stream from the cathode space, and a heater device which is arranged downstream of the at least one fuel cell and is acted on by outgoing fuel cell stream. A starting material is evaporated in an evaporator. Either the vapor temperature of the starting material which is to be evaporated in the evaporator, or the temperature of a heat-transfer medium of the evaporator, is regulated to a predetermined temperature, by varying either the hydrogen content in the outgoing anode stream or the amount of fuel which is metered in on the inlet side of the evaporator, as a function of the vapor temperature or the heat-transfer medium temperature.

### BACKGROUND AND SUMMARY OF THE INVENTION

This application claims the priority of German patent document 100 15 653.3, filed Mar. 29, 2000, the disclosure of which is expressly incorporated by reference herein.

The invention relates to a fuel cell system and a method of operating a fuel cell system.

Evaporators which are heated by hot gas or another heat-transfer medium (such as heat-transfer oil) for the evaporation of media (for example water or fuel) in a polymer electrolyte membrane fuel cell system are known. Directly heated evaporators are also known.

German patent document DE-A1 198 52 853 discloses a fuel cell system in which the off-gases from a fuel cell are supplied to an additional burner, and are also supplied to and act on a heat exchanger. Alternatively, a portion of the off-gas stream which has not been supplied to the burner is supplied directly to the heat exchanger.

One object of the invention is to provide a fuel cell system and a method for operating a fuel cell system which achieve improved utilization of the available thermal energy in the fuel cell system.

This and other objects and advantages are achieved by the fuel cell method and apparatus according to the invention, in which an operating medium of the fuel cell is evaporated in an evaporator. Either the vapor temperature of the operating medium (which is to be evaporated in the evaporator) or the temperature of a heat-transfer medium of the evaporator is regulated by varying a quantity of hydrogen in the outgoing anode stream and/or by metering fuel which is input to the inlet side of the evaporator, as a function of the vapor temperature or the heat-transfer medium temperature.

The advantage of this arrangement is that only the energy that is necessary to reach a vapor temperature is introduced into the gas stream by varying the hydrogen content or the quantity of hydrogen in the outgoing anode stream and/or by adding additional fuel. As a result, there are no unnecessary large volumetric streams of gas required in order to introduce the energy into the evaporator, or the volumetric streams of gas can be selected freely at least within certain ranges.

Other objects, advantages and novel features of the present invention will become apparent from the following detailed description of the invention when considered in conjunction with the accompanying drawings.

### BRIEF DESCRIPTION OF THE DRAWINGS

FIG. 1 is a schematic diagram of a preferred embodiment of a device for carrying out the method according to the invention;

FIG. 2 is a schematic diagram of a further preferred embodiment of a device for carrying out the method according to the invention; and

FIG. 3 is a schematic diagram of still another embodiment of a device for carrying out the method according to the invention.

### DETAILED DESCRIPTION OF THE DRAWINGS

The invention is particularly suitable for fuel cell systems in which an operating medium (preferably methanol and/or water) must be evaporated. One or more fuel cells may be provided in the fuel cell system, connected in such a way that the fuel cell system may, for example, provide electric power sufficient to operate a vehicle.

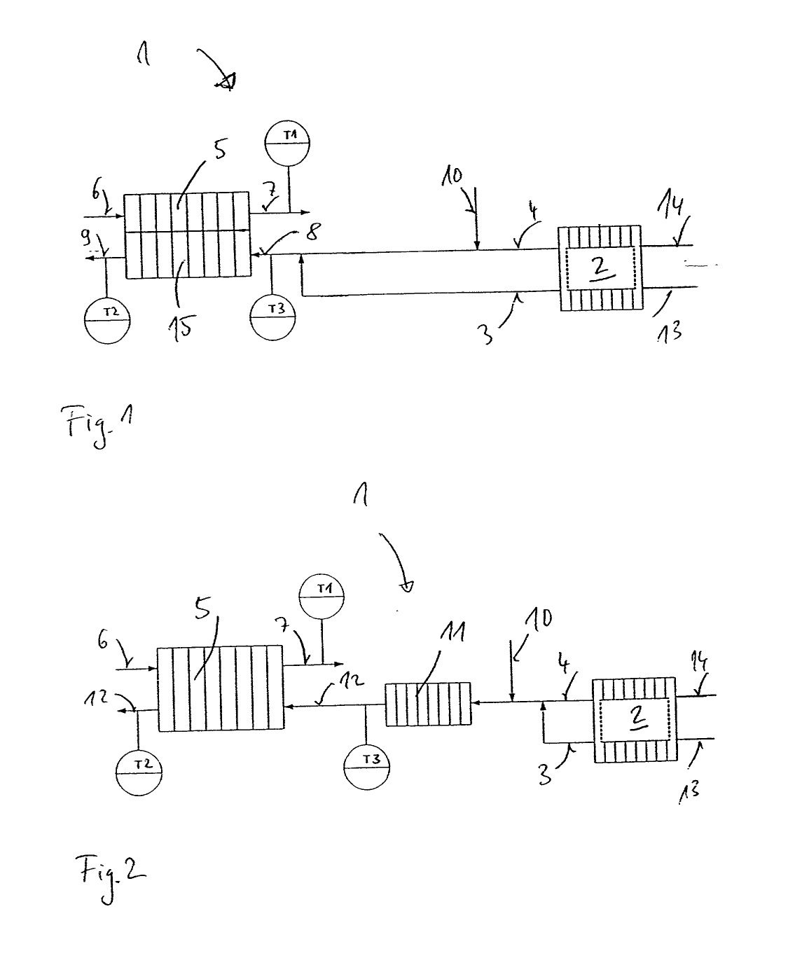

FIG. 1 shows a fuel cell system 1 having an arrangement according to the invention on the outgoing stream side of the fuel cell. The fuel cell system contains at least one fuel cell 2 having an anode space and a cathode space as well as a first medium supply line 13 for supplying a first medium to the anode space and a second medium supply line 14 for supplying a second medium to the cathode space. The incoming flow side of the at least one fuel cell 2 is not shown in detail. Preferably, hydrogen is obtained from one or more starting materials (e.g., a methanol/steam mixture) by reforming, and is supplied to the fuel cell 2. However, it is also possible to use other hydrogen-containing starting materials. An outgoing anode stream is removed from the anode space by means of a first medium outlet line 3, and an outgoing cathode stream is removed from the cathode space via a second medium outlet line 4.

The heat source of an evaporator S is arranged in a flow path of the at least one fuel cell 2, as a heater device, so that at least some fuel cell off-gas can be supplied to the heat source of the evaporator 5, which is located downstream of the fuel cell 2. Preferably, a hydrogen-containing starting material or mixture is evaporated in the evaporator 5 and is supplied to a gas generation system for obtaining hydrogen from the evaporated starting material or mixture. The hydrogen obtained is then supplied to the fuel cell 2 as operating medium. The evaporator 5 is preferably heated directly or indirectly by an outgoing stream from the fuel cell. The flow of starting material or mixture through the evaporator 5 and that of the fuel cell off-gas may be in the same or opposite directions.

In a preferred configuration, the evaporator 5 is heated by a catalytic burner 15. The outgoing cathode stream 4 and the outgoing anode stream 3 are mixed, and supplied to the evaporator 5 as reaction medium 8. There they are catalytically burnt in the catalytic burner 15. In the process, the reaction medium 8 releases energy to the starting material 6 which is to be evaporated and at least partially evaporates this material. Hydrogen obtained from the evaporated starting material 7 (for example in a reformer) is supplied to the fuel cell 2. The at least partially converted reaction medium 8 is removed, as medium 9, from the catalytic burner 15 of the evaporator 5.

If more electrical power is required from the fuel cell 2 (for example, in the event of a load change), more starting material (preferably methanol) has to be metered to the gas generation system of the fuel cell 2. As a result of the increased supply of cold, unevaporated starting material 6, the temperature falls in the evaporator 5 unless more energy is provided for the evaporation and generation of a sufficient quantity of the evaporated starting material 7.

In the event of a high energy demand, additional fuel 10 (for example, methanol or another suitable medium) may be metered into the outgoing cathode stream 4 or also into the mixed reaction medium 8 on the inlet side of the evaporator 5. Such additional fuel can also supply energy for evaporation in the catalytic burner 15 of the evaporator 5.

At the outlet of the evaporator 5, the vapor temperature of the evaporated operating medium 7 is monitored by a temperature sensor T1. According to the invention, the vapor temperature can be regulated to a predetermined value using the temperature measurements from the temperature sensor T1. It is advantageous for operation of the fuel cell system if the vapor temperature is held constantly at a predetermined level. In the event of deviations from the predetermined vapor temperature, which are recorded by T1, it is possible to vary the quantity of hydrogen in the outgoing anode stream 3 accordingly, by means of temperature regulation. In this manner, the evaporator 5 can be heated to a greater or lesser extent, and a predetermined vapor temperature can be maintained.

As an alternative, in order to vary the quantity of hydrogen in the outgoing anode stream 3, a corresponding additional quantity of fuel 10 can be metered into the catalytic burner 15 of the evaporator 5. This is advantageous if the quantity of hydrogen in the anode off-gas is not sufficient to provide enough energy in the catalytic burner 15 of the evaporator 5. The fuel 10 may be metered into the burner 15, into the outgoing cathode stream 4 or into the mixed stream of outgoing cathode stream 4 and outgoing anode stream 3, or into the outgoing anode stream 3.

It is expedient for the added fuel to be metered in such a way that no undesirable emissions or unacceptably high emission levels occur at the outlet of the catalytic burner 15.

Alternatively, it is also possible to satisfy a given basic load of the evaporator 5 with a substantially constant hydrogen content in the anode off-gas 3, and if elevated power demands are imposed on the evaporator 5, simply to meter in additional fuel 10 in order to cover the power requirements of the evaporator 5. The fuel 10 is metered in such a way that a predetermined vapor temperature can be maintained at T1. In this way, the system can follow a load change more quickly than with variation in the hydrogen content in the outgoing anode stream 3 alone.

It is also possible to provide temperature sensors T3, T2 for determining the inlet temperature and/or the outlet temperature of the medium 8 or 9, respectively, entering or emerging from the catalytic burner 15 of the evaporator 5.

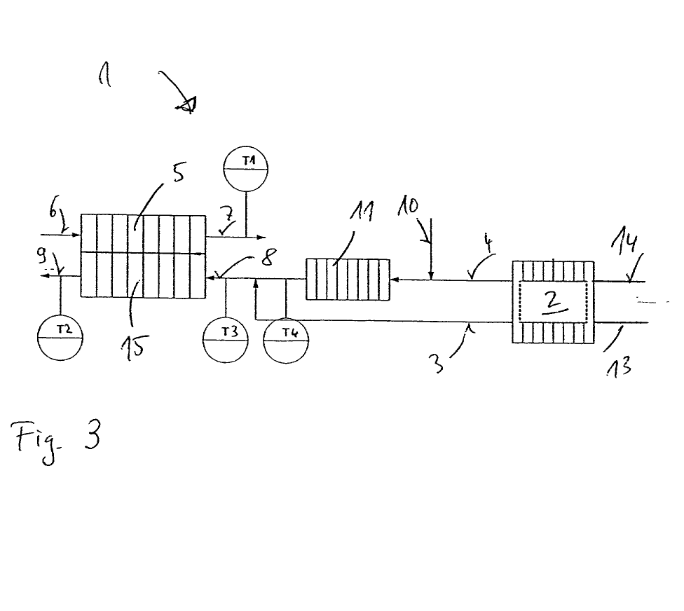

If the evaporator 5 is heated by a heat-transfer medium, as illustrated in FIG. 2, it is also possible for the temperature difference ΔT₂₋₃ between T2 and T3 to be used as a control variable for temperature regulation. In the event of an unacceptable deviation of the temperature difference ΔT₂₋₃ from a predetermined value, the hydrogen content in the outgoing anode stream 3 and/or the addition fuel 10 can be adjusted accordingly. If the temperature difference ΔT₂₋₃ is too large, the evaporator 5 is overloaded, since it has to evaporate too much starting material; more hydrogen and/or fuel 10 has to be supplied. If the temperature difference ΔT₂₋₃ is too low, the evaporator 5 is not fully loaded, since only a small quantity of starting material is being evaporated; accordingly, less hydrogen should be supplied in the outgoing anode stream 3 and/or less fuel 10 should be supplied. If the evaporator 5 is catalytically heated, however, the relationships are more complex. The outlet temperature at T2 or the inlet temperature T3 can also be provided as control variable for the temperature regulation.

In the outgoing stream from the fuel cell 2, a pilot burner 11 may also be provided in the outgoing cathode stream 4, as shown in FIG. 3. This burner catalytically burns additional fuel 10 even upstream of the evaporator 5, thus bringing the reaction medium 8 to a higher temperature, so that more thermal energy is available in the catalytic burner 15 of the evaporator 5. A further advantage of a pilot burner 11 of this type is that the emission levels are improved when additional fuel 10 is metered in.

In this case, the outgoing anode stream 3 is expediently mixed with the outgoing cathode stream 4 downstream of the burner 11. It is also possible to provide an additional temperature sensor T4 for monitoring the outlet temperature of the pilot burner 11.

In the embodiment of FIG. 1 (without pilot burner 11), the quantity of hydrogen in the outgoing anode stream 3 is regulated in such a way that there is always sufficient energy to evaporate the starting material 6 supplied in the evaporator 5. The quantity of hydrogen in the outgoing anode stream 3 can, for example, be regulated in such a way that a greater or lesser excess of hydrogen is fed through the fuel cell 2. It may be expedient for the quantity of hydrogen in the outgoing anode stream 3 to be kept substantially constant. In this case, the temperature regulation of the vapor temperature or the temperature of the catalytic burner 15 of the evaporator 5 can be achieved by means of the addition of the additional fuel 10 alone. This is advantageous for the dynamics. The use of a burner 11 is advantageous in order to avoid undesirable emissions.

FIG. 2 shows a further preferred embodiment of a fuel cell system 1 having an arrangement according to the invention on the outgoing stream side of the fuel cell. Elements which are the same as those shown in FIG. 1 are denoted by identical reference symbols.

In this preferred embodiment, the evaporator 5 is a hot-gas evaporator, in which the hot off-gas from the burner 11 is used as heat-transfer medium 12 in order to evaporate a starting material 6. The outgoing anode stream 3 and the outgoing cathode stream 4 are mixed and are fed to the catalytic burner 11 which is arranged downstream of the fuel cell 2. There, the fuel cell off-gas is burnt, preferably catalytically, and supplies a high-temperature heat-transfer medium 12 which is supplied to the evaporator 5. Also, additional operating medium 10 may be supplied upstream of the burner 11, in order to further increase the temperature of the heat-transfer medium.

Temperature regulation which regulates a predetermined vapor temperature by varying the quantity of hydrogen in the outgoing anode stream 3 and/or the addition of the fuel 10 to the burner 11 is particularly favorable. Alternatively, in this embodiment too it is possible for the temperature difference ΔT₂₋₃ of the heat-transfer medium 12 between outlet and inlet of the evaporator 5 to be recorded by means of the temperature sensors T2 and T3 and to be used as a control variable for the temperature regulation or also for the inlet temperature at T3 or the outlet temperature at T2 alone to be used. With a constant quantitative gas stream, a specific temperature difference ΔT₂₋₃ in the heat-transfer medium 12 is proportional to a defined quantity of starting material 6 to be evaporated. If the quantity of starting material which is to be evaporated is known, it is also possible to use the inlet temperature of the heat-transfer medium 12 entering the evaporator 5 (recorded by means of sensor T3) to calculate the thermal energy required for evaporation. In this case, the inlet temperature is correspondingly increased or reduced by varying the quantity of hydrogen in the outgoing anode stream 3 and/or by varying the added fuel.

In the event of a variable quantitative stream of gas, the temperature difference ΔT₂₋₃ of the heat-transfer medium 12 is preferably kept as constant as possible. As a result, a suitable amount of energy is provided for evaporation of the starting material in the evaporator 5, in each case.

In a further advantageous configuration of the invention, the quantity of hydrogen in the outgoing anode stream 3 is at least indirectly determined downstream of the fuel cell 2. In the event of a load change, the quantity of hydrogen in the outgoing stream 3 from the anode changes rapidly. For this purpose, a hydrogen sensor may be provided in the outgoing anode stream 4 and/or an oxygen sensor, preferably a lambda probe, may be provided in the outgoing cathode stream 3. The hydrogen conversion in the fuel cell 2 can be determined from a signal from the oxygen sensor and in this way the hydrogen content in the outgoing anode stream 3 can be determined.

In a further alternative embodiment, the concentration in the outgoing stream can be measured downstream of the point where outgoing anode stream 3 and outgoing cathode stream 4 are mixed. Also, the temperature can be determined downstream of the burner 11 at T3, which also reflects the quantity of hydrogen in the outgoing anode stream 3. The advantage of the latter approach is that the vapor temperature of the evaporated starting material 7 can be regulated more rapidly.

The advantages of the invention are that the efficiency of the fuel cell system is increased favorably, since the gas mass flows on the heating side of the evaporator 5 can be considerably reduced.

If the temperature is regulated by varying the quantity of hydrogen in the outgoing anode stream 3, environmentally hazardous emissions from the system are reduced, since hydrogen in the system is easier to convert than, for example, methanol as additional fuel 10, and there is also no need for additional metering of the fuel 10. If the quantity of hydrogen in the outgoing anode stream 3 is fixed and the amount of fuel 10 is varied on the other hand, more rapid regulation of the temperature of the vapor and/or of the heat-transfer medium is possible. The regulation may take place independently of the electrical load imposed on the fuel cell 2. In the event of load changes, rapid reaction may take place. Possible emissions caused by the addition of the additional fuel 10 can be largely avoided by means of the burner 11. For the same electrical output from the fuel cell 2, the overall gas generation system of the fuel cell system can be of smaller design.

The additional monitoring of the absolute quantity of hydrogen in the anode off-gas has the advantage of further increasing the system dynamics. If the quantity of hydrogen changes in the event of a load change, additional fuel 10 can very quickly be added directly into the burner 11 and/or the burner 15.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A fuel cell system comprising:
at least one fuel cell having an anode space and a cathode space;
a first medium supply line for supplying a first medium to the anode space and a first medium outlet line for removing an outgoing anode stream from the anode space;
a second medium supply line for supplying a second medium to the cathode space and a second medium outlet line for removing an outgoing cathode stream from the cathode space;
a heater device arranged in heat transfer communication with an outgoing stream of the at least one fuel cell; wherein,
the heater device comprises an evaporator;
the evaporator is arranged in a flow path of a starting material for providing an operating medium to the at least one fuel cell; and
one of the vapor temperature of the first medium, which has been evaporated in the evaporator, and the temperature of a heat-transfer medium of the evaporator, is regulated to a predetermined temperature.

2. The fuel cell system according to claim 1, wherein the evaporator has a catalytic burner as a heat source.

3. The fuel cell system according to claim 1, wherein:
a catalytic burner is arranged upstream of the evaporator, in a flow path of the outgoing anode stream and the outgoing cathode stream; and
off-gas from the catalytic burner is supplied to the evaporator as heat-transfer medium.

4. The fuel cell system according to claim 2, further comprising a catalytic burner, which can be acted on by the fuel, arranged in the outgoing cathode stream, upstream of the evaporator.

5. The fuel cell system according to claim 1, wherein a supply of fuel, which can be metered in as a function of the vapor temperature or a heat-transfer medium temperature, is provided in the outgoing cathode stream, upstream of the catalytic burner.

6. The fuel cell system according to claim 1, wherein a quantity of hydrogen in the outgoing anode stream can be adjusted as a function of the vapor temperature.

7. The fuel cell system according to claim 1, wherein one of a hydrogen sensor and an oxygen sensor is arranged downstream of the at least one fuel cell.

8. A method for operating a fuel cell system having at least one fuel cell with an anode space and a cathode space, a first medium supply line for supplying a first medium to the anode space, a first medium outlet line for removing an outgoing anode stream from the anode space, a second medium supply line for supplying a second medium to the cathode space, a second medium outlet line for removing an outgoing cathode stream from the cathode space and a heater device arranged in heat transfer communication with an outgoing fuel cell stream, downstream of the at least one fuel cell; said method comprising:
evaporating a starting material in an evaporator;
regulating one of a vapor temperature of the starting material which is to be evaporated in the evaporator, and temperature of a heat-transfer medium of the evaporator, to a predetermined temperature by varying one of a quantity of hydrogen in the outgoing anode stream, and a fuel being metered in on the inlet side of the evaporator, as a function of one of the vapor temperature and the heat-transfer medium temperature.

9. The method according to claim 8, wherein:
the outgoing cathode stream and the outgoing anode stream are converted in a catalytic burner; and
the evaporator is heated by the catalytic burner.

10. The method according to claim 8, wherein:
the outgoing cathode stream is converted in a burner; and
an outgoing burner stream and the outgoing anode stream are supplied to the evaporator for catalytic combustion.

11. The method according to claim 8, wherein:
the outgoing cathode stream and the outgoing anode stream are converted in a catalytic burner; and
a hot outgoing stream from the burner is supplied to the evaporator as heat-transfer medium.

12. The method according to claim 10, wherein additional fuel is supplied to the burner as a function of the vapor temperature or a heat-transfer medium temperature of the evaporator.

13. The method according to claim 11, wherein additional fuel is supplied to the burner as a function of the vapor temperature or a heat-transfer medium temperature of the evaporator.

14. The method according to claim 8, wherein:
a quantity of hydrogen in the outgoing anode stream is at least indirectly determined; and
fuel is metered in as a function of the determined quantity of hydrogen.
